(19) United States
(12) Patent Application Publication
(10) Pub. No.: US 2016/0362547 A1
(43) Pub. Date: Dec. 15, 2016

(54) Down and polymer mixture thermal insulating sheet

(71) Applicant: Ronie Reuben, Town of Mount Royal (CA)

(72) Inventor: Ronie Reuben, Town of Mount Royal (CA)

(21) Appl. No.: 14/545,714

(22) Filed: Jun. 10, 2015

(51) Int. Cl. C08L 67/00; B32B 5/22

(52) U.S. Cl. CPC C08L 67/00; B32B 5/22; B32B 2307/304; B32B 2262/0276; B32B 2262/062; B32B 2307/51; B32B 2307/734

(57) ABSTRACT

A light weight insulating sheet comprised of down insulation mixed with polymer fibers is described. The down and polymer fibers provide improved stretchability and lofting as well as improved drying of the insulating material. The polymer fibers may be polyester or crimped lofting fibers and these may be mixed with micro fibers to further improved lofting. A binder may be added in the form of a powder glue of be constituted by the polymeric fibers such as when subjected to heat the glue binds to the mixture or the fibers interconnect at their crossings binds the mixture.

### TECHNICAL FIELD

The present invention relates to thermal insulating sheets comprised of down mixed with polymer fibers to form a light weight insulating sheet for use in the fabrication of thermally insulated products and wherein the thermal insulating sheets have improved resiliency and lofting, a faster drying time when exposed to water, and are cheaper than full down insulation sheets.

### BACKGROUND OF THE INVENTION

The use of down in a sheet form is described in my US. Pat. No. 6,025,041. However, down is an expensive product as compared to synthetic fiber insulation, but the later does not provide the same thermal insulating factor and lightweight as down. Down insulation also when absorbed with moisture, such as when washing, requires a longer drying time as compared to synthetic fibers such as polyester fibers. Also, polymer fibers when used as an insulating product provides good resiliency, namely lofting, as compared to natural down or wool, as examples.

The use of microfibers mixed with crimped bulking fibers for use as an insulation in the fabrication of articles of apparel is known and described in U.S. Pat. No. 4,118,531 issued on Oct. 3, 1978 to the Minnesota Mining and Manufacturing Company. As described microfibers are heavier than alternative types of fibrous insulation. Since the surface area of microfibers is greater than polyester staple fibers, more air is held in place by the microfibers, which results in a deduced transfer of heat within a web containing microfibers. Although the percentage of microfibers in a web of this type of insulation is less than that of an all-microfiber web, sufficient microfibers are apparently retained to make the thermal resistance per unit of thickness of the web comparable to that of an all-microfiber web. Loft and resiliency of such a web is provided by a blend with crimped bulking fibers. The advantage of such insulation using microfibers is that the insulation is of less weight and bulk as compared with insulation using polyester staple fibers and is just as warm.

In my above mentioned U.S. Pat. No. 6,025,041, there is discussed the problems of using down as an insulation, particularly in the fabrication of articles of apparel. Down insulation from goose or duck is known to have excellent insulation properties due to their ability to retain heat. Because down is a natural product it is more expensive than synthetic fibers, such as polyester. It would therefore be desirable to use the qualities of both down and synthetic fibers to fabricate a thermally insulating material having excellent insulating properties and other features including reduce cost, faster drying time and more resistant to shrinkage and provided improved lofting as compared to down insulation.

### SUMMARY OF INVENTION

It is therefore a feature of the present invention to provide a light weight polymer insulating sheet having improved thermal efficiency, resiliency and lofting.

Another feature of the present invention is to provide a down insulating sheet comprised of down mixed with polymer fibers or natural fibers to provide improved lofting, resiliency and drying and reduced cost.

According to the above features, from a broad aspect, the present invention provides a light weight polymer insulating sheet having improved thermal efficiency. The insulating sheet is comprised of polymer fibers mixed with a predetermined quantity of down material and a binder for maintaining the polymer fibers and down material bound together in a thoroughly intermixed homogeneous mixture. The insulating sheet thus fabricated exhibits improved resiliency and lofting of the down material and a faster drying time as compared to a full-down insulation sheet.

According to a further broad aspect of the invention the insulating sheet is comprised of polyester fibers mixed with down.

According to another broad aspect of the present invention there is provided a down insulation sheet having improved lofting, resiliency and drying. The down insulation sheet is comprised of down material mixed with a predetermined quantity of polymer fibers or natural fibers and a binder for maintaining the down material and polymer fibers or natural fibers bound together in a thoroughly intermixed homogeneous mixture.

### DESCRIPTION OF THE DRAWINGS

A preferred embodiment of the present invention will now be described with reference to the accompanying drawings in which:

FIG. 1 is a simplified illustration of a system for the fabrication of the insulating sheet of the present invention;

FIG. 2 is a fragmented cross-sectional view of a polymer insulation sheet fabricated with down and polymer insulation and a binder;

FIG. 3 is another fragmented cross-sectional view of a down insulation sheet fabricated with down and polymer fibers or natural fibers and a binder, and

FIG. 4 is a perspective view of a crimped bulking fiber.

### DETAILED DESCRIPTION

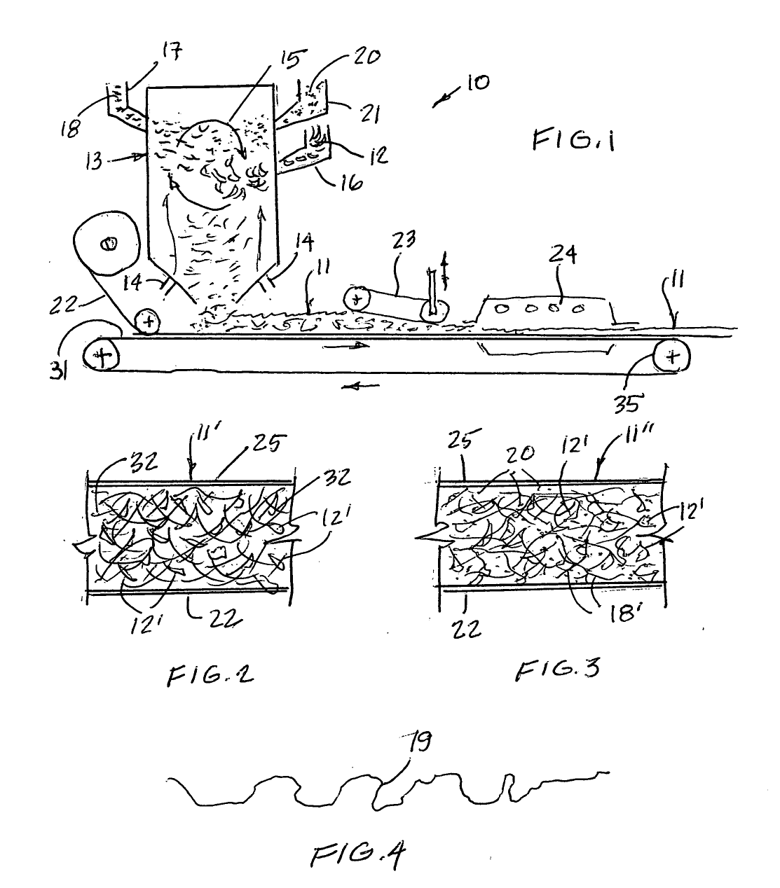

Referring now to the drawings and more particularly to FIG. 1, there is shown generally at 10 a machine or system for the fabrication of the light weight insulating sheet 11 of the present invention. As shown down insulation 12 in the form of goose or duck feather down or a mixture therof is injected or released through a chute 16 in an air mixing chamber 13 wherein air orifices 14 inject air under controlled pressure to cause a controlled turbulent mixing flow 15 in the mixing chamber. Added to the mixing chamber 15 through another chute 17, or otherwise injected are suitable polymer fibers, such as polyester fibers 18 or crimped bulking fibers 19, as illustrated in FIG. 4. A binder in the form of a powder glue 20, which react to heat may also be released in the mixture, herein the turbulence flow 15.

The mixture inside the mixing chamber propagates downward to exit by gravity through an opening 30 at the bottom of the mixing chamber to be deposited on a conveyor belt 21 or a backing fabric sheet 22, as herein illustrated which moves with the conveyor. the conveyor belt 21 is driven by a driven drum 35. The deposited mixture is a thoroughly intermixed homogeneous mixture. The speed of the conveyor determines the thickness of the insulating sheet 11. The mixed material leaving the mixing chamber 13 is then compressed by the compression belt assembly 23 and conveyed into a heat treatment chamber 24 where it is subjected to heat to either melt the powder glue to bind the down and fibers together or to soften the crimped bulking fibers or other polymeric fibers to bind together at their crossings to trap the down mixture. Accordingly, there is thus formed the insulating down and fiber mixed insulating sheet of the present invention.

FIG. 2 illustrates a mixture of down feathers 12′ and suitable polymer fibers 18′ capable of binding together when subjected to heat and trapped between the backing support sheet 22 and an opposed top fabric sheet 25. The polymer fibers 18 may be crimped bulking polymer fibers 19 such as the fiber illustrated in FIG. 4 which due to its form exhibits stretchability, as is well known in the art. Additionally, micro fibers 32 may be added to the mixture to improve bonding of more fibers while improving the loft by the use of ultra thin fibers resulting in additional air space. The bottom fabric sheet 22 and top fabric sheet 25 are fabricated from light weight material and preferably, but not exclusively, have stretchable properties to provide flexibility to the insulating sheet 11′.

As shown in FIG. 3, the insulating sheet 11″ is formed of a mixture of the down material 12′ mixed with suitable polymeric fibers or natural fibers 18′, such as wool, bamboo fibers, bean, charcoal , milk and other suitable fibers or compositions thereof having insulating and lofting properties. This mixture includes the glue powder particles 20 as above mentioned in admixture and when subjected to heat, the glue binds the mixture together. As with FIG. 3 the thermally insulating light weight mixture may be held captive between opposed fabric sheets 25 and 22 which may be formed of stretchable polymer fibers.

The light weight thermally insulating sheet as described above in its example of mixture and fabrication has a multitude of uses and not limited to articles of apparel, and as examples only, it may be used in the manufacture of duvet covers, liners for winter boots, and any other article of commercial use where light weight insulating material in sheet form is desirable. It is also pointed out that the light weight insulating sheet thus produced has improved resiliency and lofting due to the use of polymer fibers as above described. The polymer fibers also provides for a faster drying time of the mixture with down as compared to a full-down insulting sheet and provides minimal shrinking.

It is therefore within the ambit of the present invention to cover any obvious modification of the examples of the preferred embodiment described herein, provided such modifications fall within the scope of the appended claims.

1. A light weight polymer insulating sheet having improved thermal efficiency, said insulating sheet comprising polymer fibers mixed with a predetermined quantity of down material, a binder for maintaining said polymer fibers and down material bound together in a thoroughly intermixed homogeneous mixture, said insulating sheet having improved resiliency and lofting of said down material and a faster drying time as compared to an all-down insulating sheet.

2. The light weight polymer insulating sheet as claimed in claim 1 wherein said polymer fibers are polyester fibers to provide minimal shrinkage to the polymer insulating sheet when subjected to humidity or water infiltration.

3. The light weight polymer insulating sheet as claimed in claim 1 wherein said polymer fibers are crimped bulking fibers, said binder being constituted by said crimped bulking fibers being heat treated in said mixture with said down material wherein said crimped bulking fibers are soften to bind at their crossing to provide said binder throughout said homogeneous mixture.

4. The light weight polymer insulating sheet as claimed in claim 1 wherein said polymer fibers when subjected to heat bind at their crossings to provide said binder.

5. The light weight polymer insulating sheet as claimed in claim 3 wherein said crimped bulking fibers are mixed with microfibers wherein when subjected to heat both said crimped bulking fibers and microfibers bond at their crossings to provide improved air retention, stretchability and loft.

6. The light weight polymer insulating sheet as claimed in claim 1 wherein there is further provided a light weight support fabric sheet bonded to one of opposed surfaces of said polymer insulating sheet.

7. The light weight polymer insulating sheet as claimed in claim 1 wherein said homogeneous mixture is held captive between a pair of light weight fabric sheets.

8. The light weight polymer insulating sheet as claimed in claim 7 wherein said light weight fabric sheet are formed of stretchable polymer fibers.

9. A down insulating sheet having improved lofting, resiliency and drying, said down insulating sheet comprising down material mixed with a predetermined quantity of polymer fibers or naira; fibers, and a binder for maintaining said down material and polymer fibers or natural fibers bound together in a thoroughly intermixed homogeneous mixture.

10. The down insulating sheet as claimed in claim 9 wherein said polymer fibers are polyester fibers to provide minimal shrinkage to said down insulating sheet.

11. The down insulating sheet as claimed in claim 9 wherein said natural fibers are one of wool, bamboo, bean, charcoal, milk, or mixtures thereof or the like fibrous materials having thermally insulating properties.

12. The down insulating sheet as claimed in claim 9 wherein said polymer fibers are crimped bulking fibers, said binder being constituted by said crimped bulking fibers being heat treated in said mixture with said down material wherein said crimped fibers are soften to bind at their crossings to provide said binder throughout said homogeneous mixture.

13. The down insulating sheet as claimed in claim 12 wherein said crimped bulking fibers are mixed with micro fibers wherein when bonded at their crossings provides for added loft resulting in improved resiliency and stretchability of said down insulating sheet.

14. The down insulating sheet as claimed in claim 9 wherein there is further provided a light weight support fabric sheet bonded to one of opposed surfaces of said down insulating sheet.

15. The down insulating sheet as claimed in claim 9 wherein said homogeneous mixture is held captive between a pair of light weight fabric sheets.

16. The down insulating sheet as claimed in claim 15 wherein said light weight fabric sheets are formed of stretchable polymer fibers.
